(19) United States
(12) Patent Application Publication
(10) Pub. No.: US 2003/0178868 A1
(43) Pub. Date: Sep. 25, 2003

(54) Service van

(76) Inventor: Robert M. Lapsley, Sagamore Hills, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/104,618

(22) Filed: Mar. 22, 2002

(51) Int. Cl. B60P 3/00

(52) U.S. Cl. 296/24.1

(57) ABSTRACT

A service van is provided including a service structure manufactured in two distinct sections. A first section of welded steel construction includes multiple storage compartments. The welded steel storage compartments at least partially support a cap structure which encloses the service structure and includes two non-metallic side panels and a front panel.

### FIELD OF THE INVENTION

This invention related to service vans, more particularly to vans having van bodies including welded steel compartments.

### BACKGROUND OF THE INVENTION

It is common practice in the truck body industry to produce service van vehicles which are different from the standard models offered by large auto makers, in order to meet the particular needs of customers. This production process typically involves the supply, by a customer, of a truck assembly (cab, engine, chassis, drive system) less any structure upon the rear portion of the truck chassis to a van producer. Truck assemblies are originally obtained from large truck manufacturers such as Ford, General Motors, etc. A van body, supported by the chassis, is then added to meet customer requirements. Parameters determined by the van producer include overall size, rear door placement and size, and inclusion of additional accessories. Additional accessories include additional doors upon the sides of the van body and, most commonly, shelved compartments.

Although customized layout and construction of compartments for individual customers may be performed by the van producer, more commonly a customer chooses from a small number of common configurations. These configurations either maximize the use of surface area upon the exterior of the van body or have a desirable aesthetic appearance or both.

Within the industry van bodies are manufactured from fiberglass reinforced plywood sidewalls and aluminum sheet and post materials. Compartment fabrication methods have been limited to cutting and removal of part of the existing sidewall and the manual fabrication of compartment bodies and shelving within the interior of the van which aligns with the cutout. A drawback to this method is that fiberglass reinforced plywood is an expensive material, much of which is being discarded during the fabrication process. Further, there are a limited number of methods of attaching doors and compartment covers to the sidewalls.

A service body is known structure commonly installed upon a truck chassis. A service body includes a section including compartments, a floor section therebetween, and is formed from steel using welded joints. Welded construction provides stability and durability. Existing service bodies have drawbacks. Only the compartments are enclosed and as a result any materials stored on the floor section, outside of the compartments are exposed to conditions inherent with vehicle travel and parking. The height and overall size of the service body is also limited in order to keep the additional weight added to the vehicle at a minimum. As a result, work areas, especially those which are enclosed are minimal or non-existent. What is desired is a vehicle having a work area which is lightweight, structurally sound and provides a large enclosed space.

### SUMMARY OF THE INVENTION

The present invention overcomes disadvantages in the prior art by providing an improved service van. The invention provides in one aspect a service van with a cab and includes a service structure. The service structure includes two welded steel storage structures providing structural properties of strength, rigidity and durability. The storage structures include compartments and a fender panel, wherein the storage structures have substantially planar top surfaces for supporting a cap structure. The compartments and fender panel are welded together. The cap structure includes two side panels formed of lightweight fiberglass reinforced plywood and a lightweight roof. The storage structures and cap structure are bonded together using glue. In another aspect of the invention, the cap structure includes a front panel with an access door leading to the cab of the service van.

The structure of the present invention provides a significant advantage in cost of manufacture. FRP, which is a costly material, is partially replaced with welded steel structures which are less costly. Along with cost savings, the use of welded steel construction for the storage structures of the van body provides structural integrity. By using a combination of steel and FRP, the structural benefits of steel are realized, where required, and the lightweight advantages of FRP are realized within the van body enclosure. These and other aspects of the invention are herein described in particularized detail with reference to the accompanying Figures.

### BRIEF DESCRIPTION OF THE FIGURES

FIG. 1 is a side view of a service van of the present invention;

FIG. 1(a) is a rear view of a service van of the present invention;

FIG. 2 is a perspective view of a service van of the present invention;

FIG. 3 is a side view of an alternate embodiment of the van of the present invention including four compartments;

FIG. 4 is a side view of an alternate embodiment of the van of the present invention including five compartments;

FIG. 5 is a section view of a joint between a side panel and front panel;

FIG. 6 is a perspective view of the inside of the service structure of the service van;

FIG. 7 is a sectional view of a joint between the side storage structure and cap structure; and

FIG. 8 is a perspective view of the inside of the service structure of the service van.

### DETAILED DESCRIPTION OF PREFERRED AND ALTERNATE EMBODIMENTS

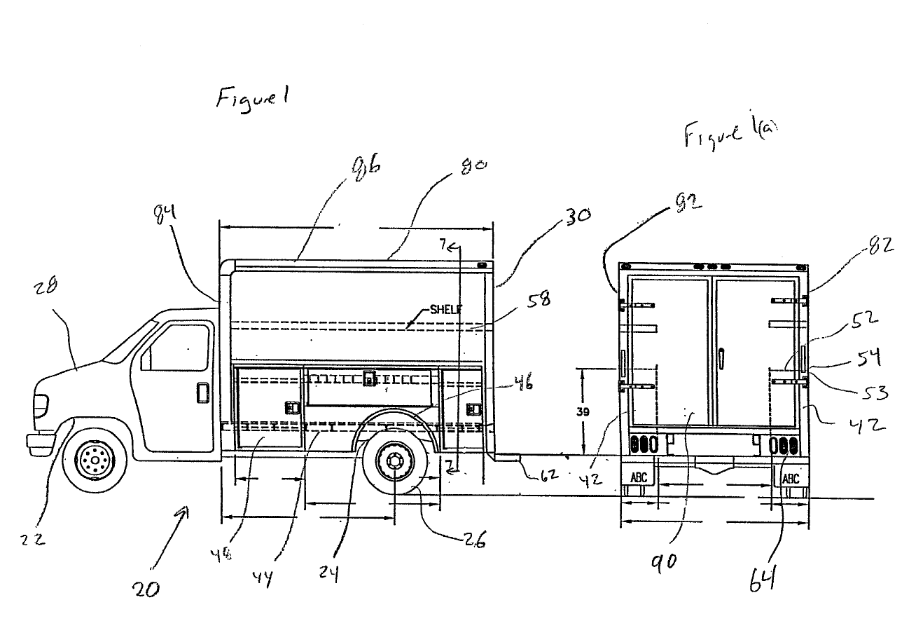

Referring to the drawings, FIGS. 1 and 1a illustrate a preferred van 20 according to the invention. The van 20, as described in more detail below, comprises a service structure 30, an engine 22, chassis 24, drive system 26 and a cab 28. The service structure 30 comprises storage structures 42 in combination with a cap structure 80 and a floor panel 44.

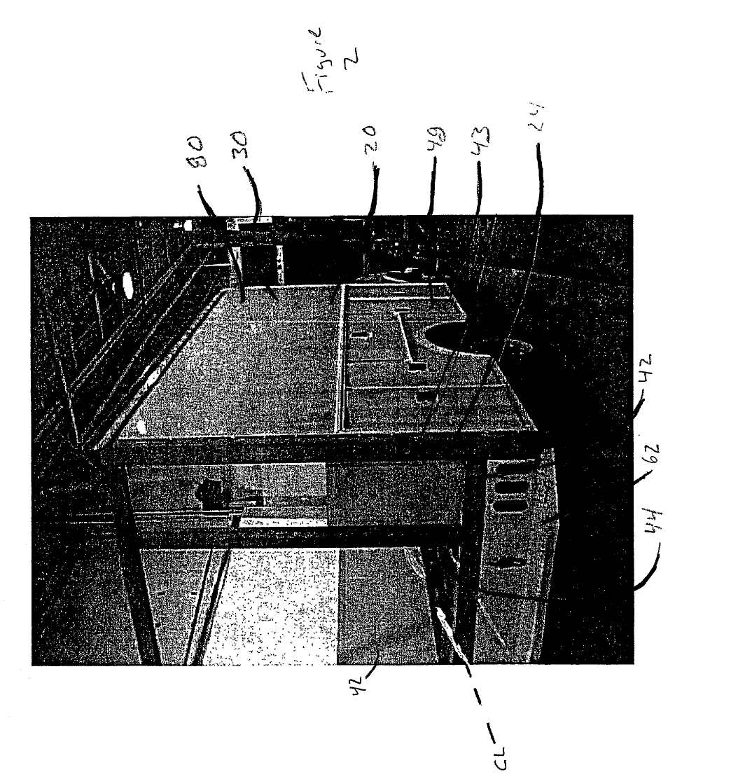

Referring to FIGS. 1, 1a and 2 the service structure 30 is located rearward of the cab 28 on the van 20 and is supported by the chassis 24 of the van. The service structure 30 may include two side storage structures 42 which are spaced apart and a floor panel 44 between the side structures 42. The floor panel 44 may be made of steel or of another material such as fiberglass reinforced plywood (FRP). The floor panel 44 may be made skidproof by covering it with a non-skid surface. The floor panel 44 is placed on top of a steel substructure that is welded between the side storage structures 42. The storage structures 42 may be rectangular shaped assemblies including an indentation 46 or “wheel well” in the position above the rear axle of the van. The storage structures 42 may be constructed of welded steel. The storage structures 42 may include one or more storage compartments 48 or doors which allow access to the interior of the service structure 30.

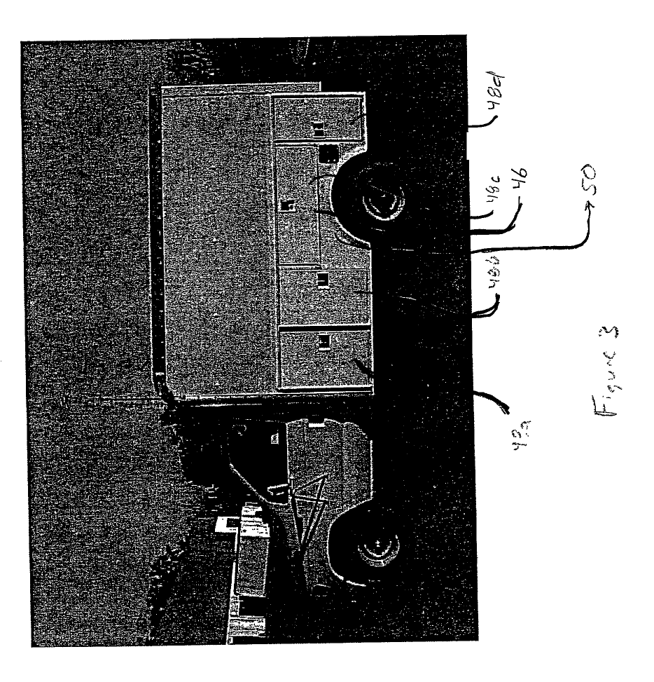

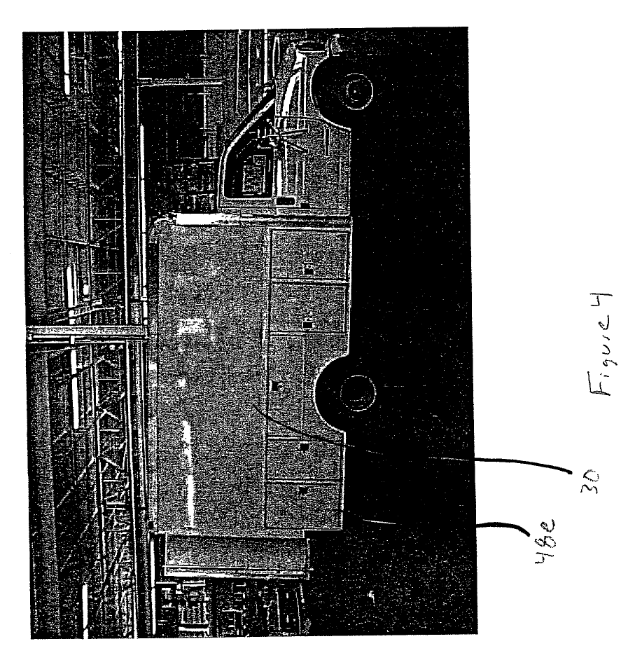

The storage compartments 48 may be oriented along the length of the storage structures 42 extending from the front of the service structure 30 to the rear. The storage compartments 48 may have access openings on the exterior surface 43 of the storage structure 42 and extend inwards towards a centerline CL (shown extending from the front to the rear of the van). Alternatively, if there is merely an access door in a certain position there is no structure extending towards the centerline (not shown). Each storage compartment 48 may include shelving of a type known in the art. The depth of the compartments 48 may be less than the distance to the centerline of the van, thus, leaving a partially open space above the floor panel. The compartments 48 may be shaped rectangularly and maximize the use of space on the exterior surface 43 of the storage structure 42. As shown in FIG. 3, an embodiment of the invention is shown in which each storage structure 42 includes four storage compartments (48a, 48b, 48c 48d). The first compartment 48a is nearest the cab 28 and has a rectangular shape with height exceeding width, the second compartment 48b is adjacent and rearward of the first compartment 48a and has a rectangular shape with height exceeding width, and the third compartment 48c is adjacent and rearward of the second compartment 48b and has a rectangular shape with width exceeding height. The third compartment 46c is located above the wheelwell indentation 46 in the storage structure 42, thus, maximizing the use of available space. The area around the wheelwell indentation is referred to as the fender panel 50. The fender panel 50 may be welded to the surrounding compartments in order to give structural properties of strength durability and rigidity to the service body. The fourth compartment 48d is adjacent and rearward of the third compartment 48c and is rectangular in shape with height exceeding width. In this embodiment, the service structure 30 has a length of about ten (10) feet. In another embodiment of the invention, shown in FIG. 4 the service structure 30 has a length of about twelve (12) feet and includes a fifth compartment 48e rearwards of the fourth compartment 48d. The fifth compartment 48e is rectangular in shape with height exceeding width.

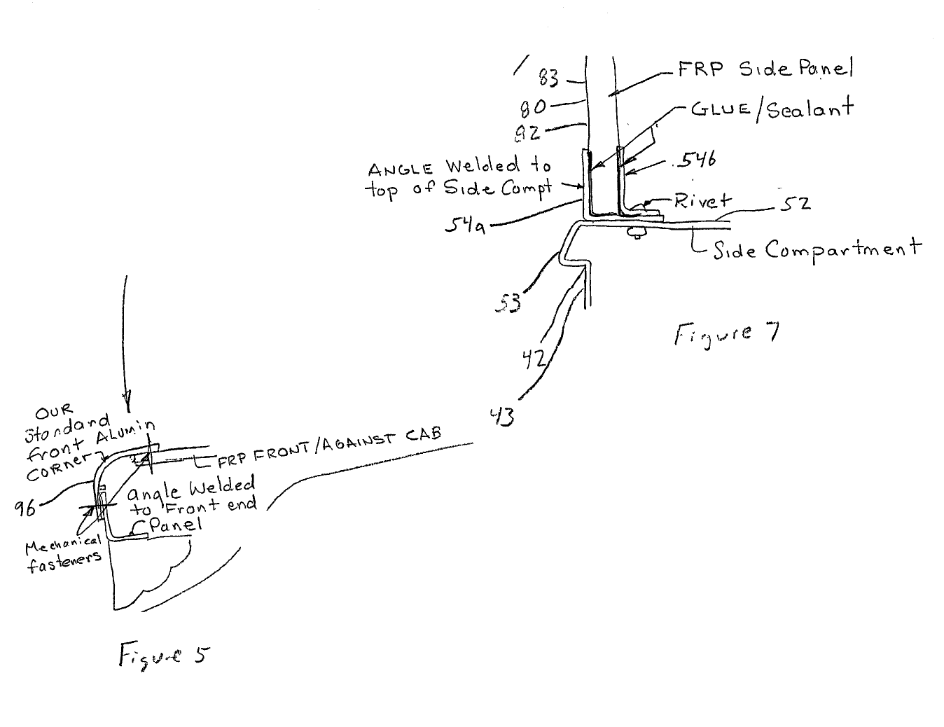

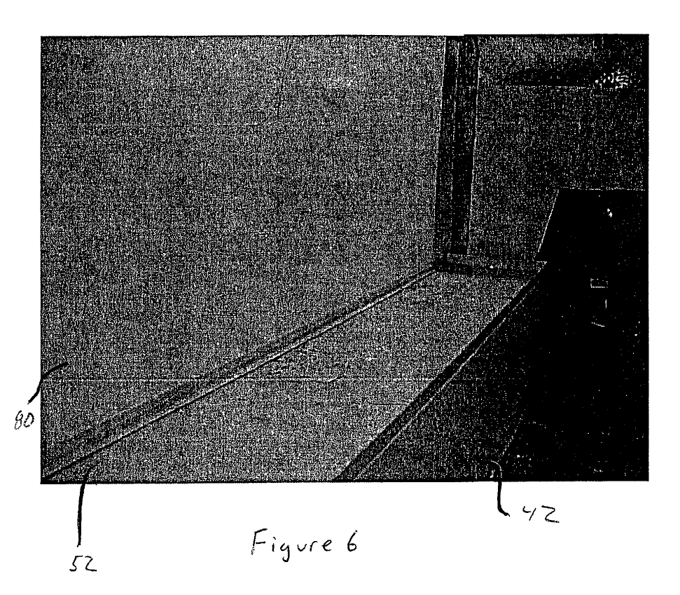

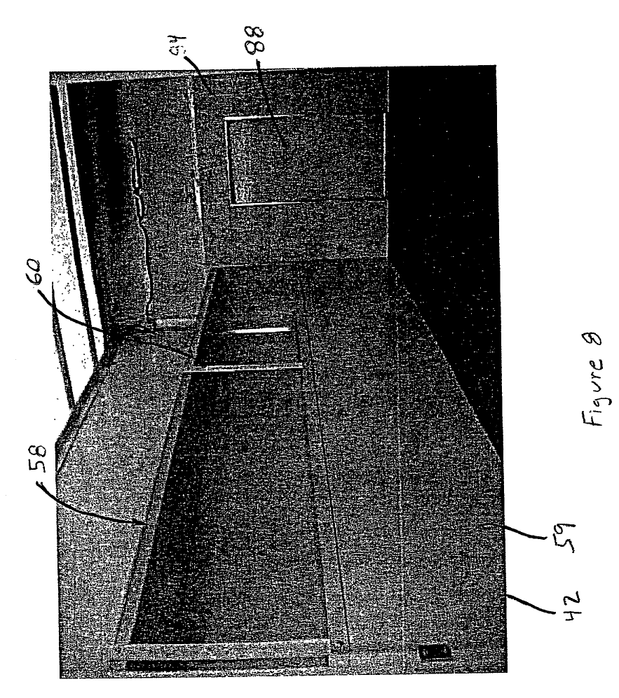

Referring back to FIGS. 1, 1(a) and 6, 7 and 8 each side storage structure 42 may include a substantially planar top surface 52. The top surface 52 facilitates support of the cap structure 80 located above the storage structure 42. Flanges 54a, 54b may be attached to the top surface 52 which allow a superior joint to be formed between the storage structure 42 and the cap structure 80. The flange 54a may be oriented along the exterior edge 53 of the storage structures 42. Flange 54a may be welded to the top surface 52 of the storage structures 42. Flange 54b may be riveted to the top of storage structure 42. Flange 54b is placed on the inside of Flange 54a, creating a gap to hold the side panels 82. As shown in FIG. 8, the storage structures 42 also support shelving 58 which is not part of any compartment 48. Posts 60 are affixed to the interior edge 59 of the storage structure 42 and extend upwardly therefrom. The shelves are supported by the posts 60.

The service structure 30 may also include a step bumper 62, tail lights and other lighting 64 known in the art to be used on vans and hinges and closures of a type known in the art upon the compartments.

Referring to FIGS. 1, 1a and 8, the cap structure 80 may be supported at least partially by the side storage structures 42 and may have a box shape which encloses the area between the side storage structures 42. The cap structure 80 provides an enclosed area in the service structure 30 for additional storage or for use as a workspace. The cap structure 80 may include two side panels 82, a front panel 84, and a roof 86. As noted above, the side panels 82 are supported by the planar top surfaces 52 of the side storage structures 42. Each side panel 82 may be made from FRP or Aluminum Sheet and Post. The side panels 82 are rectangular, extend vertically and attach to the roof 86. In combination, the storage structures 42 and side panels 82 combined have a height of about seventy-two (72) inches. In another embodiment of the invention the combined height is about seventy-eight (78) inches. This provides room for an individual to stand and perform tasks within an enclosed area. This large enclosed area is provided without creating an overly heavy structure by using combined steel/FRP construction. Each side panel 82 may be glued to the flanges 54a and 54b upon the planar top surface 52 of the side storage structure 42. Glue types which may be used include sikoflex 221 polyurethane sealant glue. The exterior surfaces 83 of the side panels 82 and side storage structures 43 may be substantially coplanar with each other when the side panels 82 are glued in place. Because the storage structures 42 make up a significant portion of the exterior surface of the side of the van, the side panels 82 may be smaller than that of prior art vans. This results in a cost savings in FRP used to construct the side panels.

The front panel 84 acts as part of the service structure 30 enclosure adjacent to the cab 28 of the van 20. Similar to the side panels 82, the front panel 84 may be made from FRP. The front panel 84 may extend between the side storage structures 42 and is attached on either side to the side panels 82 and at the top to the roof 86. As shown in FIG. 5, an aluminum corner piece 96, known in the art, can be used to make this connection. The front panel 84 may include a door 88 which allows access to the cab 28 of the van 20 as shown in FIG. 8. Referring back to FIGS. 1 and 1a, the roof 86 is supported in combination by the side panels 82 and the front panel 84. The roof 86 may be formed from lightweight materials including one or more of the following: aluminum, translucent plastic and light steel cross supports. Doors 90, of a type well known in the art are used to enclose the back side of the van body 30.

The van 20 also includes a cab 28, engine 22, chassis 24 and drive system 26 (transmission, driveshaft, axles, wheels). These components may be purchased as an assembly from an automaker.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents.

1. A van comprising:
a cab;
a service structure rearwards of said cab, said service structure including:
two steel side storage structures spaced apart and having substantially planar top surfaces, said storage structures including multiple welded steel compartments;
a floor panel between said side storage structures;
a cap structure at least partially supported by said storage structures, said cap structure including:
two non-metallic side panels; and
a roof supported by said side panels.

2. The van of claim 1 wherein said roof is translucent.

3. The van of claim 1 wherein said roof is made from aluminum.

4. The van of claim 1 further including two shelves supported by said storage structures.

5. The van of claim 1 wherein said side panels are comprised of fiberglass reinforced plywood.

6. The van of claim 1 wherein said side panels are supported respectively by said side storage structures of said service structure.

7. The van of claim 6 wherein said side storage structures include flanges attached to said substantially planar top surfaces and said side panels are glued to said flanges.

8. The van of claim 7 wherein each of said planer top surfaces of said storage structures includes an exterior edge and at least one of said flanges is attached along said exterior edges causing an exterior surface of each side panel to be substantially co-planar with an exterior surface of each storage structure.

9. The van of claim 1 wherein said cap structure further includes a front panel adjacent said cab and extending between said two side panels and said storage structures.

10. The van of claim 9 wherein said front panel includes an door providing access to said cab.

11. The van of claim 1 wherein said floor panel is comprised of fiberglass reinforced plywood.

12. The van of claim 1 wherein each side storage structure includes a first, a second, a third and a fourth compartment and a fender panel including an indentation providing clearance for a rear axle of the van.

13. The van of claim 12 wherein said first compartment is nearest said cab and has a rectangular shape with height exceeding width, said second compartment is adjacent and rearward of said first compartment and has a rectangular shape with height exceeding width, said third compartment is adjacent and rearward of said second compartment and has a rectangular shape with width exceeding height and said fourth compartment is adjacent and rearward of said third compartment and is rectangular in shape with height exceeding width.

14. The van of claim 1 wherein each side storage structure includes a first, a second, a third, a fourth and a fifth compartment and a fender panel including an indentation providing clearance for a rear axle of the van.

15. The van of claim 1 wherein each side structure further includes a fender panel.

16. A van comprising:
a cab;
a service structure rearwards of said cab, said service structure including:
two side storage structures spaced apart and having substantially planar top surfaces, said storage structures including multiple welded steel compartments, fender panels and flanges upon said storage structures;
a floor panel between said side storage structures;
a cap structure supported at least partially by said storage structures said cap structure including:
two side panels glued to said flanges;
a roof supported by said side panels; and
a front panel attached to said side panels and said roof, said front panel including an access door to said cab.

17. The van of claim 16 wherein said steel compartments are welded to said fender panel.

18. The van of claim 16 wherein said flanges are oriented along exterior sides of said storage structures.

19. A method of fabricating a van comprising the steps of:
providing a chassis, cab, engine and drive system;
providing multiple storage structures and mounting said storage structures upon said chassis;
fabricating a cap structure partially atop said storage structures, said cap structure including two side panels made from fiber reinforced plywood, a front panel made from fiber reinforced plywood and a roof.

20. The method of claim 19 wherein said cap structure is attached to said storage structures using glue.
